(19) United States
(12) Patent Application Publication
(10) Pub. No.: US 2013/0238225 A1
(43) Pub. Date: Sep. 12, 2013

(54) ENGINE CONTROL APPARATUS

(71) Applicant: DENSO CORPORATION, Kariya-city (JP)

(72) Inventor: Tetsuo MORITA, Nagoya (JP)

(73) Assignee: DENSO CORPORATION, Kariya-city (JP)

(21) Appl. No.: 13/788,011

(22) Filed: Mar. 7, 2013

(30) Foreign Application Priority Data
Mar. 12, 2012 (JP) 2012-054934

(51) Int. Cl. F02D 41/04

(52) U.S. Cl. CPC F02D 41/042
USPC 701/112

(57) ABSTRACT

An engine control apparatus is provided for controlling an engine of a motor vehicle. The engine control apparatus is configured to automatically stop the engine by stopping combustion in the engine when a predetermined automatic stop condition is satisfied and restart the engine by driving a starter when a predetermined restart condition is satisfied. The engine control apparatus includes a calculator and a condition changer. The calculator calculates an accumulated value by accumulating a starter deterioration-related value each time the engine is started or restarted by the starter; the accumulated value is indicative of the degree of deterioration of the starter. The condition changer changes, when the accumulated value has increased to reach a threshold value, the predetermined automatic stop condition so as to lower the frequency of the engine being automatically stopped and restarted and thereby suppress deterioration of the starter.

### CROSS-REFERENCE TO RELATED APPLICATION

This application is based on and claims priority from Japanese Patent Application No. 2012-54934, filed on Mar. 12, 2012, the content of which is hereby incorporated by reference in its entirety into this application.

### BACKGROUND

1. Technical Field

The present invention relates to engine control apparatuses.

2. Description of Related Art

There are known engine control apparatuses which have a so-called idling stop function. More specifically, those engine control apparatuses are configured to detect manipulations for stopping or starting a motor vehicle, such as an accelerator manipulation or a brake manipulation by a driver of the vehicle, and automatically stop and restart an engine of the vehicle based on the detected manipulations. With the idling stop function, it is possible to achieve advantageous effects such as reduction in fuel consumption of the engine.

On the other hand, for a motor vehicle which is equipped with an engine control apparatus that has the idling stop function, the engine of the vehicle is repeatedly automatically stopped and restarted. Consequently, compared to a motor vehicle which is equipped with an engine control apparatus that has no idling stop function, the number of times a starter of the vehicle is driven to start or restart the engine is considerably increased. As a result, the starter may be more easily deteriorated and in the worst case, it may become unable to start the engine.

To solve the above problem, Japanese Unexamined Patent Application Publication No. 2001-263210 discloses a technique of prescribing a condition for inhibiting the engine from being automatically stopped and restarted. More specifically, according to the technique, both the starter-driving time (i.e., the length of time during which the starter is driven to crank the engine) and the number of starter-driving times (i.e., the number of times the starter is driven to start or restart the engine) are accumulated. When both the accumulated starter-driving time and the accumulated number of starter-driving times have increased to reach their respective threshold values, it is determined that the inhibiting condition is satisfied. Consequently, upon satisfaction of the inhibiting condition, the engine is inhibited from being automatically stopped and restarted. As a result, wear of gears of the starter is suppressed, and damage to the gears is accordingly prevented.

However, with the above technique, once the inhibiting condition is satisfied, it is no longer possible to automatically stop and restart the engine unless the starter is replaced with a new one. That is, with the above technique, the total running distance of the vehicle for which the engine is allowed to be automatically stopped and restarted is shortened.

In addition, the total running distance for which the engine is allowed to be automatically stopped and restarted may be increased by setting a stricter condition for automatically stopping the engine. However, in this case, both the number of times the engine is automatically stopped and restarted and the length of time during which the engine is automatically stopped and restarted once would be reduced. As a result, the advantageous effects, which can be achieved with the idling stop function of the engine control apparatus, would be lowered.

### SUMMARY

According to an exemplary embodiment, there is provided an engine control apparatus for controlling an engine of a motor vehicle. The engine control apparatus is configured to automatically stop the engine by stopping combustion in the engine when a predetermined automatic stop condition is satisfied and restart the engine by driving a starter when a predetermined restart condition is satisfied. The engine control apparatus includes a calculator and a condition changer. The calculator calculates an accumulated value by accumulating a starter deterioration-related value each time the engine is started or restarted by the starter; the accumulated value is indicative of the degree of deterioration of the starter. The condition changer changes, when the accumulated value has increased to reach a threshold value, the predetermined automatic stop condition so as to lower the frequency of the engine being automatically stopped and restarted and thereby suppress deterioration of the starter.

With the above configuration, in the initial stage of use of the vehicle, it is possible to allow the engine to be frequently automatically stopped and restarted, thereby reliably achieving the advantageous effect of reducing the fuel consumption of the engine. Moreover, after the degree of deterioration of the starter has increased to a considerable level, it is possible to lower the frequency of the engine being automatically stopped and restarted, thereby suppressing deterioration of the starter. As a result, it is possible to extend the service life of the starter and increase the total running distance of the vehicle for which the engine is allowed to be automatically stopped and restarted.

In a further implementation, the predetermined automatic stop condition may include that the running speed of the vehicle sensed by a vehicle speed sensor is lower than or equal to a predetermined speed. The condition changer may change the predetermined automatic stop condition by lowering the predetermined speed.

The predetermined automatic stop condition may also include that the temperature of cooling water of the engine sensed by a temperature sensor is higher than or equal to a predetermined temperature. The condition changer may change the predetermined automatic stop condition by increasing the predetermined temperature.

The starter deterioration-related value may be equal to 1. In this case, the accumulated value represents the accumulated number of times the engine is started or restarted by the starter.

Alternatively, the starter deterioration-related value may be calculated by the calculator as a load imposed on the starter each time the starter is driven to start or restart the engine. In this case, the accumulated value represents the accumulated load imposed on the starter.

The engine may be inhibited from being automatically stopped and restarted when the accumulated value is greater than an upper limit value that is greater than the threshold value. The condition changer may change the predetermined automatic stop condition by setting the predetermined automatic stop condition to a first automatic stop condition when the accumulated value is less than or equal to the threshold value and to a second automatic stop condition when the accumulated value is greater than the threshold value and less than or equal to the upper limit value.

### BRIEF DESCRIPTION OF THE DRAWINGS

The present invention will be understood more fully from the detailed description given hereinafter and from the accompanying drawings of exemplary embodiments, which, however, should not be taken to limit the invention to the specific embodiments but are for the purpose of explanation and understanding only.

In the accompanying drawings:

FIG. 1 is a schematic view illustrating the overall configuration of an automotive engine system which includes an Electronic Control Unit (ECU) according to a first embodiment;

FIG. 2 is a schematic view illustrating the setting of first and second automatic stop conditions according to the first embodiment in comparison with the setting of an automatic stop condition according to a prior art;

FIG. 3 is a flow chart illustrating a process of the ECU for calculating an accumulated value according to the first embodiment;

FIG. 4 is a flow chart illustrating a process of the ECU for automatically stopping an engine of the automotive engine system according to the first embodiment; and

FIG. 5 is a flow chart illustrating a process of the ECU for calculating the accumulated value according to a second embodiment.

### DESCRIPTION OF EMBODIMENTS

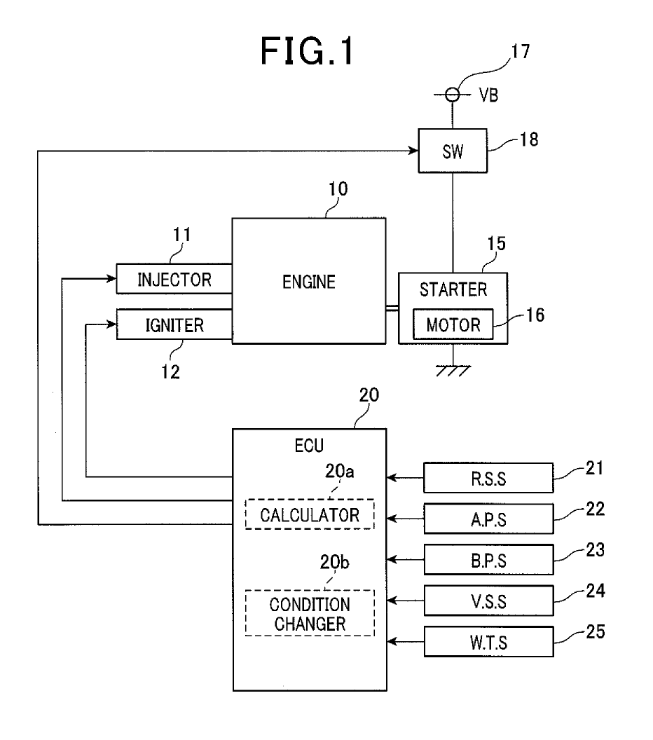

Exemplary embodiments will be described hereinafter with reference to FIGS. 1-5. It should be noted that for the sake of clarity and understanding, identical components having identical functions throughout the whole description have been marked, where possible, with the same reference numerals in each of the figures and that for the sake of avoiding redundancy, descriptions of the identical components will not be repeated.

### First Embodiment

FIG. 1 shows the overall configuration of an automotive engine system which includes an Electronic Control Unit (ECU) 20 according to a first embodiment. The ECU 20 is provided to perform various controls, such as a fuel injection quantity control, an ignition timing control and an idling stop control, for an engine 10 of the automotive engine system. The engine 10 may be, for example, a four-cylinder internal combustion engine of a motor vehicle.

As shown in FIG. 1, the automotive engine system further includes at least one fuel injector 11, an igniter 12, a starter 15, a battery (denoted by VB in FIG. 1) 17, and a switch circuit (denoted by SW in FIG. 1) 18. The fuel injector 11 is configured to inject fuel into the engine 10. The igniter 12 is configured to generate ignition sparks at spark plugs that are respectively provided in the cylinders of the engine 10, thereby igniting the air-fuel mixture in the cylinders. In addition, though not shown in FIG. 1, the automotive engine system also includes a throttle valve that is configured to regulate the amount of air sucked into the cylinders of the engine 10.

The starter 15 is provided to start the engine 10. Specifically, the starter 15 includes an electric motor 16 that generates torque when supplied with electric power from the battery 17, thereby imparting initial rotation to the engine 10. Between the starter 15 and the battery 17, there is provided the switch circuit 18 to selectively allow or inhibit the electric power supply from the battery 17 to the motor 16 of the starter 15. More specifically, when the switch circuit 18 is turned on, electric power is supplied from the battery 17 to the motor 16; otherwise, when the switch circuit 18 is turned off, the electric power supply from the battery 17 to the motor 16 is interrupted.

In addition, the switch circuit 18 is configured to be turned on either by a manual operation by a driver of the vehicle or by receipt of an engine-starting command from the ECU 20.

The ECU 20 is configured with a microcomputer of a well-known type, which includes, for example, a CPU (Central Processing Unit), a ROM (Read Only Memory), a RAM (Random Access Memory) and I/O (Input/Output) devices. The ECU 20 is configured to receive sensing signals outputted from various sensors provided in the automotive engine system and perform various controls based on information contained in the sensing signals.

Specifically, the various sensors provided in the automotive engine system include, for example, a rotational speed sensor (abbreviated to R. S. S. in FIG. 1) 21, an accelerator position sensor (abbreviated to A. P. S. in FIG. 1) 22, a brake position sensor (abbreviated to B. P. S. in FIG. 1) 23, a vehicle speed sensor (abbreviated to V. S. S. in FIG. 1) 24, and a water temperature sensor (abbreviated to W. T. S. in FIG. 1) 25. The rotational speed sensor 21 is configured to output a rectangular sensing signal (or crank angle signal) in a cycle of, for example, 10° CA of the engine 10; the sensing signal is indicative of the rotational speed of the engine 10 (i.e., the rotational speed of a crankshaft of the engine 10). The accelerator position sensor 22 is configured to output a sensing signal that is indicative of the position of an accelerator pedal of the vehicle; based on the sensing signal, it is possible to determine the amount of depression (or manipulation) of the accelerator pedal by the driver of the vehicle. The brake position sensor 23 is configured to output a sensing signal that is indicative of the position of a brake pedal of the vehicle; based on the sensing signal, it is possible, to determine whether there is a depression (or a manipulation) of the brake pedal by the driver of the vehicle. The vehicle speed sensor 24 is configured to output a sensing signal that is indicative of the running speed of the vehicle. The water temperature sensor 25 is configured to output a sensing signal that is indicative of the temperature of cooling water of the engine 10.

As mentioned previously, the various controls performed by the ECU 20 include, for example, the fuel injection quantity control, the ignition timing control and the idling stop control. In addition, it is also possible to provide both a first ECU and a second ECU instead of the single ECU 20; the first ECU is dedicated to perform only the idling stop control while the second ECU is configured to perform all the other controls performed by the ECU 20 than the idling stop control.

The idling stop control is a control for automatically stopping the engine 10 when a predetermined automatic stop condition is satisfied and restarting the engine 10 when a predetermined restart condition is satisfied. In addition, the engine 10 is automatically stopped by stopping combustion in the engine 10 and restarted either by driving the starter 15 or by resuming the combustion in the engine 10.

The predetermined automatic stop condition includes, for example, the following: (1) at least one of the requirement that the amount of depression (or manipulation) of the accelerator pedal is equal to zero and the requirement that the brake peal is depressed (or manipulated); (2) the temperature of the cooling water of the engine 10 is higher than or equal to a predetermined temperature (e.g., 35° C.); and (3) the vehicle speed is lower than or equal to a predetermined speed (e.g., 10 km/h). In addition, the predetermined automatic stop condition may further include that the number of times the engine 10 is cranked for a given length of time is less than a predetermined number. On the other hand, the predetermined restart condition includes, for example, at least one of the requirement that the accelerator pedal is depressed (or manipulated) and the requirement that the depression (or manipulation) of the brake pedal is released.

Under the idling stop control, the engine 10 is repeatedly automatically stopped and restarted. Consequently, compared to an engine for which no idling stop control is performed, the number of times the starter 15 is driven to start or restart the engine 10 is considerably increased, thereby accelerating deterioration of the starter 15. As a result, the service life of the starter 15 may be shortened.

To solve the above problem, in the present embodiment, the ECU 20 is configured to: calculate an accumulated value AV by accumulating a starter deterioration-related value SDRV each time the engine 10 is started or restarted by the starter 15; and limit the engine 10 from being automatically stopped and restarted by the idling stop control depending on the accumulated value AV that is indicative of the degree of deterioration of the starter 15. More specifically, in the present embodiment, the starter deterioration-related value SDRV is set to 1, and the accumulated value AV represents the accumulated number of times the engine 10 is started or restarted by the starter 15.

Moreover, in the present embodiment, the engine 10 is allowed to be automatically stopped by the idling stop control only when the predetermined automatic stop condition is satisfied.

To increase the total running distance of the vehicle for which the engine 10 is allowed to be automatically stopped and restarted by the idling stop control, it may be possible to keep the predetermined automatic stop condition strict (or difficult to be satisfied) from the start of use of the vehicle. However, in this case, both the number of times the engine 10 is automatically stopped and restarted by the idling stop control during the service life of the starter 15 and the length of time during which the engine 10 is automatically stopped and restarted once by the idling stop control would be reduced. As a result, the advantageous effect of reducing the fuel consumption of the engine 10 by the idling stop control would be lowered.

In view of the above, in the present embodiment, the predetermined automatic stop condition is set to be less strict at the start of use of the vehicle and changed to be strict when the accumulated value AV (i.e., the accumulated number of times the engine 10 is started or restarted by the starter 15) has increased to exceed a threshold value THY (e.g., 80,000 times). In other words, when the accumulated value AV has increased to exceed the threshold value THV, the predetermined automatic stop condition is changed so as to lower the frequency of the engine 10 being automatically stopped and restarted by the idling stop control and thereby suppress deterioration of the starter 15.

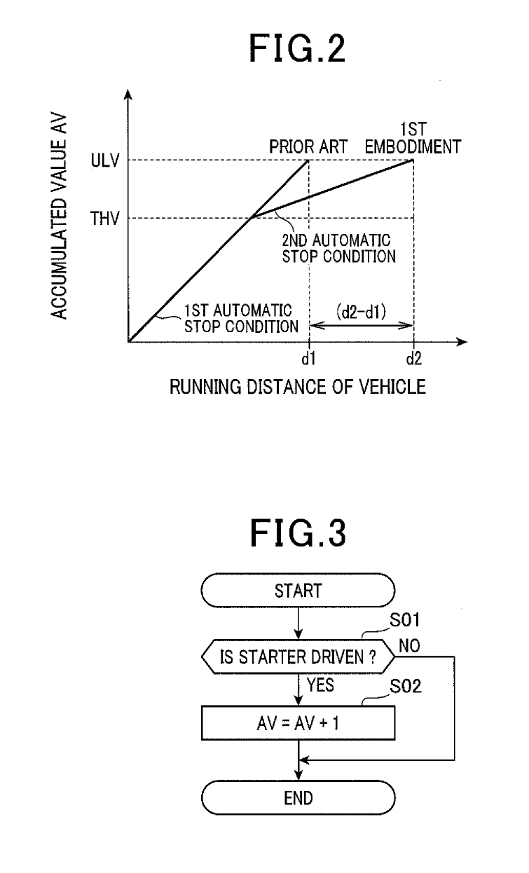

More specifically, as shown in FIG. 2, according to a prior art, the predetermined automatic stop condition is set to be less strict at the start of use of the vehicle and kept unchanged until the accumulated value AV (i.e., the accumulated number of times the engine 10 is started or restarted by the starter 15) has increased to reach an upper limit value ULV. Here, the upper limit value ULV is defined such that when the accumulated value AV is greater than the upper limit value ULV, the engine 10 is inhibited from being automatically stopped and restarted by the idling stop control.

In other words, according to the prior art, the same automatic stop condition is used when the accumulated value AV is in the range of 0 to ULV. Consequently, the total running distance of the vehicle for which the engine 10 is allowed to be automatically stopped and restarted by the idling stop control is equal to d1.

In comparison, in the present embodiment, the predetermined automatic stop condition is set to a first automatic stop condition at the start of use of the vehicle, and kept unchanged until the accumulated value AV has increased to reach the threshold value THV. The first automatic stop condition is the same as the automatic stop condition used in the prior art. Further, the predetermined automatic stop condition is changed to a second automatic stop condition when the accumulated value AV exceeds the threshold value THV, and kept unchanged until the accumulated value AV has increased to reach the upper limit value ULV. The second automatic stop condition is stricter (or more difficult to be satisfied) than the first automatic stop condition.

In other words, in the present embodiment, when the accumulated value AV is in the range of 0 to THV, the first automatic stop condition is used to determine whether or not to allow the engine 10 to be automatically stopped by the idling stop control. Moreover, when the accumulated value AV is greater than the threshold value THV but not greater than the upper limit value ULV, the second automatic stop condition is used to determine whether or not to allow the engine 10 to be automatically stopped by the idling stop control. Consequently, the total running distance of the vehicle for which the engine 10 is allowed to be automatically stopped and restarted by the idling stop control is equal to d2 that is longer than d1.

In addition, the first automatic stop condition includes, for example, the following: (1) the brake peal is depressed (or manipulated); (2) the vehicle speed is lower than or equal to a first predetermined speed (e.g., 10 km/h); and (3) the temperature of the cooling water of the engine 10 is higher than or equal to a first predetermined temperature (e.g., 35° C.). On the other hand, the second automatic stop condition includes, for example, the following: (1) the brake peal is depressed; (2) the vehicle speed is lower than or equal to a second predetermined speed (e.g., 5 km/h) that is lower than the first predetermined speed; (3) and the temperature of the cooling water of the engine 10 is higher than or equal to a second predetermined temperature (e.g., 80° C.) that is higher than the first predetermined temperature.

Setting the first and second automatic stop conditions as above, it is more difficult to perform the idling stop control for the engine 10 under the second automatic stop condition than under the first automatic stop condition. Consequently, after the accumulated value AV has increased to exceed the threshold value THV, the frequency of the engine 10 being automatically stopped and restarted by the idling stop control is lowered and thus the increasing rate of the accumulated value AV is also lowered. As a result, compared to the prior art, the total running distance of the vehicle for which the engine 10 is allowed to be automatically stopped and restarted by the idling stop control is increased by, for example, (d2−d1) as shown in FIG. 2.

FIG. 3 shows a process of the ECU 20 for calculating the accumulated value AV according to the present embodiment.

First, at step S01, a determination is made as to whether the switch circuit 18 (see FIG. 1) is turned from off to on, in other words, whether the starter 15 is driven to start or restart the engine 10.

If the determination at step S01 results in a “NO' answer, then the process directly goes to the end. Otherwise, if the determination at step S01 results in a “YES” answer, then the process proceeds to step S02.

At step S02, the accumulated value AV is newly calculated by adding 1 (i.e., the starter deterioration-related value SDRV in the present embodiment) to the previous accumulated value AV. Then, the process goes to the end.

In addition, though not shown in FIG. 3, the initial accumulated value AV is set to 0. In the present embodiment, since the accumulated value AV is updated by adding 1 thereto each time the starter 15 is driven to start or restart the engine 10, this value represents the accumulated number of times the engine 10 is started or restarted by the starter 15. Therefore, it is possible to reliably determine the degree of deterioration of the starter 15 based on the accumulated value AV.

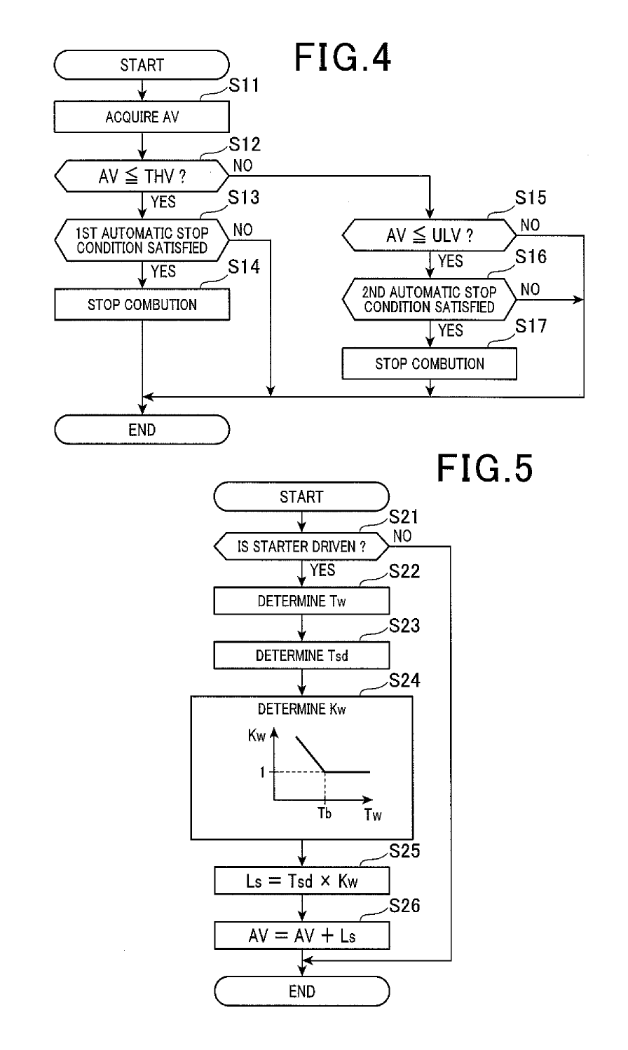

FIG. 4 shows a process of the ECU 20 for automatically stopping the engine 10.

First, at step S11, the then accumulated value AV is acquired.

At step S12, a determination is made as to whether the accumulated value AV is less than or equal to the threshold value THV.

If the determination at step S12 results in a “YES” answer, then the process proceeds to step S13.

At step S13, a further determination is made as to whether the first automatic stop condition is satisfied.

If the determination at step S13 results in a “NO” answer, then the process directly goes to the end. Otherwise, if the determination at step S13 results in a “YES” answer, then the process proceeds to step S14.

At step S14, the engine 10 is automatically stopped by stopping combustion in the engine 10. Then, the process goes to the end.

On the other hand, if the determination at step S12 results in a “NO” answer, then the process proceeds to step S15.

At step S15, a further determination is made as to whether the accumulated value AV is less than or equal to the upper limit value ULV.

If the determination at step S15 results in a “NO” answer, then the process directly goes to the end. Otherwise, if the determination at step S15 results in a “YES” answer, then the process proceeds to step S16.

At step S16, a still further determination is made as to whether the second automatic stop condition is satisfied.

If the determination at step S16 results in a “NO” answer, then the process directly goes to the end. Otherwise, if the determination at step S16 results in a “YES” answer, then the process proceeds to step S17.

At step S17, the engine 10 is automatically stopped by stopping combustion in the engine 10. Then, the process goes to the end.

According to the present embodiment, it is possible to achieve the following advantageous effects.

In the present embodiment, the ECU 20 is configured to automatically stop the engine 10 by stopping combustion in the engine 10 when the predetermined automatic stop condition is satisfied and restart the engine 10 by driving the starter 15 when the predetermined restart condition is satisfied. As shown in FIG. 1, the ECU 20 functionally includes a calculator 20a and a condition changer 20b. The calculator 20a calculates the accumulated value AV by accumulating the starter deterioration-related value SDRV each time the engine 10 is started or restarted by the starter 15. The accumulated value AV is indicative of the degree of deterioration of the starter 15. The condition changer 20b changes, when the accumulated value AV has increased to reach the threshold value THV, the predetermined automatic stop condition so as to lower the frequency of the engine 10 being automatically stopped and restarted by the idling stop control and thereby suppress deterioration of the starter 15.

With the above configuration, in the initial stage of use of the vehicle, it is possible to allow the engine 10 to be frequently automatically stopped and restarted by the idling stop control, thereby reliably achieving the advantageous effect of reducing the fuel consumption of the engine 10 by the idling stop control. Moreover, after the degree of deterioration of the starter 15 has increased to a considerable level, it is possible to lower the frequency of the engine 10 being automatically stopped and restarted by the idling stop control, thereby suppressing deterioration of the starter 15. As a result, it is possible to extend the service life of the starter 15 and increase the total running distance of the vehicle for which the engine 10 is allowed to be automatically stopped and restarted by the idling stop control.

In addition, it should be noted that each of the calculator 20 and condition changer 20b of the ECU 20 can be implemented by a hardwired logic circuit, a programmed logic circuit or a combination of hardwired and programmed logic hybrid circuits.

In the present embodiment, the engine 10 is inhibited from being automatically stopped and restarted by the idling stop control when the accumulated value AV is greater than the upper limit value ULV. The condition changer 20b of the ECU 20 changes the predetermined automatic stop condition by setting the predetermined automatic stop condition to the first automatic stop condition when the accumulated value AV is less than or equal to the threshold value THV and to the second automatic stop condition when the accumulated value AV is greater than the threshold value THV and less than or equal to the upper limit value ULV.

With the above configuration, it is possible to easily and suitably change the predetermined automatic stop condition. Moreover, when the accumulated value AV is in the range of 0 to THV, the less-strict first automatic stop condition is used to determine whether or not to allow the engine 10 to be automatically stopped by the idling stop control. Consequently, with the first automatic stop condition, it is possible to preferentially achieve the advantageous effect of reducing the fuel consumption of the engine 10 by the idling stop control. Moreover, when the accumulated value AV is in the range of THV to ULV, the strict second automatic stop condition is used to determine whether or not to allow the engine 10 to be automatically stopped by the idling stop control. Consequently, with the second automatic stop condition, it is possible to achieve the advantageous effect of extending the running distance of the vehicle to the point where the accumulated value AV reaches the upper limit value ULV while achieving the advantageous effect of reducing the fuel consumption of the engine 10 by the idling stop control. Furthermore, when the accumulated value AV is greater than the upper limit value ULV, the engine 10 is inhibited from being automatically stopped and restarted by the idling stop control. Consequently, it is possible to suppress deterioration of the starter 15, thereby extending the service life of the starter 15.

In the present embodiment, the starter deterioration-related value SDRV is equal to 1, and the accumulated value AV represents the accumulated number of times the engine 10 is started or restarted by the starter 15.

Consequently, with the accumulated value AV, it is possible to easily and reliably determine the degree of deterioration of the starter 15.

In the present embodiment, the first automatic stop condition includes that the vehicle speed is lower than or equal to the first predetermined speed, and the second automatic stop condition includes that the vehicle speed is lower than or equal to the second predetermined speed that is lower than the first predetermined speed.

With the above configuration, under the second automatic stop condition, the engine 10 is allowed to be automatically stopped and restarted by the idling stop control at lower vehicle speeds than under the first automatic stop condition. Consequently, the frequency of the engine 10 being automatically stopped and restarted by the idling stop control under the second automatic stop condition is lower than that under the first automatic stop condition. As a result, it is possible to suppress deterioration of the starter 15, thereby extending the service life of the starter 15.

In addition, the second predetermined speed in the second automatic stop condition may be set to 0 km/h. In this case, the engine 10 is allowed to be automatically stopped and restarted by the idling stop control only when the vehicle is in a stopped state.

In general, if the engine 10 is automatically stopped and restarted with the temperature of the engine 10 (or the temperature of the cooling water of the engine 10) being low, the load imposed on the starter 15 to restart the engine 10 will be high, thus accelerating deterioration of the starter 15.

In view of the above, in the present embodiment, the first automatic stop condition includes that the temperature of the cooling water of the engine 10 is higher than or equal to the first predetermined temperature, and the second automatic stop condition includes that the temperature of the cooling water of the engine 10 is higher than or equal to the second predetermined temperature that is higher than the first predetermined temperature.

With the above configuration, under the second automatic stop condition, the engine 10 is allowed to be automatically stopped and restarted by the idling stop control at higher temperatures of the cooling water of the engine 10 than under the first automatic stop condition. Consequently, the frequency of the engine 10 being automatically stopped and restarted by the idling stop control under the second automatic stop condition is lower than that under the first automatic stop condition. As a result, it is possible to suppress deterioration of the starter 15, thereby extending the service life of the starter 15.

In addition, the accumulated value AV being greater than the threshold value THV indicates that deterioration of the starter 15 has advanced to a considerable level. Further, with the advance of deterioration of the starter 15, it becomes easier for a failure of the starter 15 to occur in starting or restarting engine 10. On the other hand, with increase in the temperature of the cooling water of the engine 10, it becomes more difficult for a failure of the starter 15 to occur in starting or restarting engine 10. Therefore, by setting the second predetermined temperature in the second automatic stop condition to be higher than the first predetermined temperature in the first automatic stop condition, it is possible to lower the possibility for a failure of the starter 15 to occur in starting or restarting engine 10.

### Second Embodiment

In the previous embodiment, the starter deterioration-related value SDRV is set to 1, and the accumulated value AV represents the accumulated number of times the engine 10 is started or restarted by the starter 15.

In comparison, in this embodiment, the starter deterioration-related value SDRV is calculated as the starter load (i.e., the load imposed on the starter 15) each time the starter 15 is driven to start or restart the engine 10; thus, the accumulated value AV represents the accumulated starter load (i.e., the accumulated load imposed on the starter 15 to start or restart the engine 10).

More specifically, the starter load increases with the starter-driving time (i.e., the length of time during which the starter 15 is driven to crank the engine 10). Moreover, the starter load also increases with decrease in the temperature of the cooling water of the engine 10. Therefore, in the present embodiment, the calculator 20a of the ECU 20 first determines a load coefficient Kw based on the temperature of the cooling water of the engine 10 using a map and then multiplies the starter-driving time by the load coefficient Kw to obtain the starter load. Thereafter, the calculator 20a calculates the accumulated value AV by accumulating the starter load.

In addition, the map is predetermined based on the results of an experiment and stored in the ROM of the ECU 20; the map represents the relationship between the load coefficient Kw and the temperature of the cooling water of the engine 10.

FIG. 5 shows a process of the calculator 20a of the ECU 20 for calculating the accumulated value AV according to the present embodiment.

First, at step S21, a determination is made as to whether the switch circuit 18 (see FIG. 1) is turned from off to on, in other words, whether the starter 15 is driven to start or restart the engine 10.

If the determination at step S21 results in a “NO' answer, then the process directly goes to the end. Otherwise, if the determination at step S21 results in a “YES” answer, then the process proceeds to step S22.

At step S22, the temperature Tw of the cooling water of the engine 10 is determined based on the sensing signal outputted from the temperature sensor 25.

At step S23, the starter-driving time Tsd is determined based on the sensing signal outputted from the rotational speed sensor 21. More specifically, the starter-driving time Tsd is determined as the length of time from when rotation of the crankshaft of the engine 10 is started by the starter 15 until the engine 10 is brought into a complete explosion state (or the rotational speed of the engine 10 reaches a complete explosion speed).

At step S24, the load coefficient Kw is determined based on the temperature Tw of the cooling water of the engine 10 using the map.

In addition, according to the map, in the range of the temperature Tw being higher than or equal to a threshold temperature Tb (e.g., 80° C.), the load coefficient Kw is kept constant at 1. On the other hand, in the range of the temperature Tw being lower than the threshold temperature Tb, the load coefficient Kw increases with decrease in the temperature Tw. Here, the threshold temperature Tb is defined as a temperature at which the engine 10 is brought into a warm-up state.

At step S25, the starter load Ls is calculated by multiplying the starter-driving time Tsd by the load coefficient Kw.

At step S26, the accumulated value AV is newly calculated by adding the starter load Ls to the previous accumulated value AV. Then, the process goes to the end.

In addition, though not shown in FIG. 5, the initial accumulated value AV is set to 0. In the present embodiment, since the accumulated value AV is updated by adding the starter load Ls thereto each time the starter 15 is driven to start or restart the engine 10, this value represents the accumulated starter load. Therefore, it is possible to reliably determine the degree of deterioration of the starter 15 based on the accumulated value AV.

While the above particular embodiments have been shown and described, it will be understood by those skilled in the art that various modifications, changes, and improvements may be made without departing from the spirit of the present invention.

(1) In the previous embodiments, the predetermined automatic stop condition is set to the first automatic stop condition when the accumulated value AV is in the range of 0 to THV and to the second automatic stop condition when the accumulated value AV is greater than the threshold value THV but not greater than the upper limit value ULV. That is, the predetermined automatic stop condition is changed only once.

However, the predetermined automatic stop condition may also be changed a plurality of times. For example, the predetermined automatic stop condition may be changed using a map that matches three or more different ranges of the accumulated value AV respectively to three or more different automatic stop conditions.

Moreover, it is also possible to: keep the predetermined automatic stop condition constant when the accumulated value AV is in the range of 0 to THV; and change the predetermined automatic stop condition once or more after the accumulated value AV exceeds the threshold value THY.

(2) In the previous embodiments, the predetermined automatic stop condition is changed by changing both the required range of the vehicle speed and the required range of the temperature of the cooling water of the engine 10.

However, the predetermined automatic stop condition may also be changed by changing only one of the required range of the vehicle speed and the required range of the temperature of the cooling water of the engine 10.

Moreover, in the previous embodiments, only the single threshold value THV is used for changing both the required range of the vehicle speed and the required range of the temperature of the cooling water of the engine 10.

However, it is also possible to use both a first threshold value THV1 for changing the required range of the vehicle speed and a second threshold value THV2 for changing the required range of the temperature of the cooling water of the engine 10.

(3) In the previous embodiments, both the first and second automatic stop conditions include that the brake peal is depressed (or manipulated).

However, both the first and second automatic stop conditions may be modified to include that the amount of depression (or manipulation) of the brake pedal is greater than or equal to a predetermined amount.

Moreover, the first automatic stop condition may include that the amount of depression of the brake pedal is greater than or equal to a first amount, and the second automatic stop condition may include that the amount of depression of the brake pedal is greater than or equal to a second amount that is greater than the first amount.

In addition, the amount of depression of the brake pedal can be determined based on the sensing signal outputted from the brake position sensor 23.

(4) In the previous embodiments, the first automatic stop condition includes that the temperature of the cooling water of the engine 10 is higher than or equal to the first predetermined temperature (e.g., 35° C.), and the second automatic stop condition includes that the temperature of the cooling water is higher than or equal to the second predetermined temperature (e.g., 80° C.).

However, the first automatic stop condition may be modified to include that the temperature of the cooling water is in the range of the first predetermined temperature to an upper limit temperature (e.g., 95° C.), and the second automatic stop condition may be modified to include that that the temperature of the cooling water is in the range of the second predetermined temperature to the upper limit temperature.

(5) The predetermined automatic stop condition in the previous embodiments may be modified to further include that the time interval between two consecutive starting or restarting operations of the engine 10 by the starter 15 is longer than a predetermined length of time.

Further, the first automatic stop condition may be modified to include that the time interval between two consecutive starting or restarting operations of the engine 10 by the starter 15 is longer than a first length of time; the second automatic stop condition may be modified to include that the time interval between two consecutive starting or restarting operations of the engine 10 by the starter 15 is longer than a second length of time that is longer than the first length of time.

(6) In the previous embodiments, the number of requirements included in the first automatic stop condition is equal to the number of requirements included in the second automatic stop condition.

However, the second automatic stop condition may include more requirements than the first automatic stop condition. For example, the required range of the temperature of the cooling water of the engine 10 may be omitted from the first automatic stop condition, while the second automatic stop condition maintains the required range of the temperature of the cooling water of the engine 10.

(7) In the second embodiment, the starter load Ls is determined based on both the starter-driving time Tsd and the temperature Tw of the cooling water of the engine 10.

However, it is also possible to determine the starter load Ls based on only one of the starter-driving time Tsd and the temperature Tw of the cooling water of the engine 10.

Moreover, it is also possible to calculate the starter load Ls as the product of the starter-driving time Tsd, the load coefficient kw and a load coefficient Ks. Here, the load coefficient Ks is introduced for taking into account the difference in the starter load Ls between a restart of the engine 10 after an automatic stop of the engine 10 and a start of the engine 10 using an ignition key. More specifically, the starter load Ls for restarting the engine 10 after an automatic stop of the engine 10 is less than that for starting the engine 10 using the ignition key. Therefore, by introducing the load coefficient Ks, it is possible to more accurately determine the starter load Ls.

What is claimed is:

1. An engine control apparatus for controlling an engine of a motor vehicle, the engine control apparatus being configured to automatically stop the engine by stopping combustion in the engine when a predetermined automatic stop condition is satisfied and restart the engine by driving a starter when a predetermined restart condition is satisfied, the engine control apparatus comprising:
a calculator that calculates an accumulated value by accumulating a starter deterioration-related value each time the engine is started or restarted by the starter, the accumulated value being indicative of the degree of deterioration of the starter; and
a condition changer that changes, when the accumulated value has increased to reach a threshold value, the predetermined automatic stop condition so as to lower the frequency of the engine being automatically stopped and restarted and thereby suppress deterioration of the starter.

2. The engine control apparatus as set forth in claim 1, wherein the predetermined automatic stop condition includes that a running speed of the vehicle sensed by a vehicle speed sensor is lower than or equal to a predetermined speed, and
the condition changer changes the predetermined automatic stop condition by lowering the predetermined speed.

3. The engine control apparatus as set forth in claim 1, wherein the predetermined automatic stop condition includes that a temperature of cooling water of the engine sensed by a temperature sensor is higher than or equal to a predetermined temperature, and
the condition changer changes the predetermined automatic stop condition by increasing the predetermined temperature.

4. The engine control apparatus as set forth in claim 1, wherein the starter deterioration-related value is equal to 1, and the accumulated value represents the accumulated number of times the engine is started or restarted by the starter.

5. The engine control apparatus as set forth in claim 1, wherein the starter deterioration-related value is calculated by the calculator as a load imposed on the starter each time the starter is driven to start or restart the engine, and the accumulated value represents the accumulated load imposed on the starter.

6. The engine control apparatus as set forth in claim 1, wherein the engine is inhibited from being automatically stopped and restarted when the accumulated value is greater than an upper limit value that is greater than the threshold value, and
the condition changer changes the predetermined automatic stop condition by setting the predetermined automatic stop condition to a first automatic stop condition when the accumulated value is less than or equal to the threshold value and to a second automatic stop condition when the accumulated value is greater than the threshold value and less than or equal to the upper limit value.
